(19) United States
(12) Patent Application Publication
(10) Pub. No.: US 2021/0064803 A1
(43) Pub. Date: Mar. 4, 2021

(54) SIMULATION METHOD, SIMULATION DEVICE, AND COMPUTER READABLE MEDIUM STORING PROGRAM

(71) Applicant: SUMITOMO HEAVY INDUSTRIES, LTD., Tokyo (JP)

(72) Inventors: Nariaki Matsumiya, Kanagawa (JP); Ryouta Hirose, Kanagawa (JP)

(21) Appl. No.: 17/011,654

(22) Filed: Sep. 3, 2020

(30) Foreign Application Priority Data
Sep. 3, 2019 (JP) 2019-160572

(51) Int. Cl. G06F 30/28; G06F 30/25

(52) U.S. Cl. CPC G06F 30/28; G06F 2113/08; G06F 30/25

(57) ABSTRACT

A simulation method including when a fluid is represented by the plurality of particles, the plurality of beads are defined for each of the particles, and behaviors of a plurality of beads are analyzed by using a path integral molecular dynamics method, changing a value of Planck's constant appearing in Hamiltonian describing the plurality of beads to be larger than an actual value of Planck's constant, and analyzing the behaviors by applying the Hamiltonian in which the value of Planck's constant is changed, and obtaining a kinematic viscosity of the fluid represented by the Hamiltonian in which the value of Planck's constant is changed, based on the analysis result.

### RELATED APPLICATIONS

The content of Japanese Patent Application No. 2019-160572, on the basis of which priority benefits are claimed in an accompanying application data sheet, is in its entire incorporated herein by reference.

### BACKGROUND

### Technical Field

Certain embodiments of the present invention relates to a simulation method, a simulation device, and a computer readable medium storing a program.

### Description of Related Art

Simulation using the molecular dynamics method is used to analyze the microscopic behavior of a phenomenon. When the equation of motion to which the individual particles follow can be written down, it is possible to investigate the combination analysis of different phases, the state near the critical point, turbulence, or the like. In particular, it is required to analyze a system with a high Reynolds number.

The Reynolds number is proportional to the size of the system and the velocity of the flow, and is inversely proportional to the viscosity of the fluid. Therefore, it is possible to simulate a system with a high Reynolds number by enlarging the system or increasing the velocity of the fluid. However, in such a method, the system itself to be simulated becomes large and it is necessary to make the time step width fine, so that the calculation time becomes huge.

When a system consisting of a plurality of particles representing a low-viscosity fluid can be defined, a system with a high Reynolds number can be represented without changing the size of the system. The superfluid phenomenon is a phenomenon in which the viscosity of a fluid becomes almost zero at cryogenic temperatures. For example, in the liquid helium 4, viscosity is rapidly reduced at an absolute temperature of about 2 K or less. When the reduced viscosity state can be reproduced by the molecular dynamics method, it will help the simulation of a system with a high Reynolds number.

A path integral molecular dynamics method (hereinafter referred to as PIMD method), which is one of methods for performing simulation of a quantum system is described in the related art.

### SUMMARY

According to an embodiment of the invention, there is provided a simulation method including: when a fluid is represented by the plurality of particles, the plurality of beads are defined for each of the particles, and behaviors of a plurality of beads are analyzed by using a path integral molecular dynamics method, changing a value of Planck's constant appearing in Hamiltonian describing the plurality of beads to be larger than an actual value of Planck's constant, and analyzing the behaviors by applying the Hamiltonian in which the value of Planck's constant is changed; and obtaining a kinematic viscosity of a fluid represented by the Hamiltonian in which the value of Planck's constant is changed, based on an analysis result.

According to another embodiment of the invention, there is provided a simulation device including: an input device that receives simulation conditions when a fluid is represented by a plurality of particles, a plurality of beads are defined for each of the particles, and behaviors of the plurality of beads are analyzed by simulation using a path integral molecular dynamics method, and change information for changing a value of Planck's constant from an actual value of Planck's constant; and a proces sing device that changes the value of Planck's constant appearing in Hamiltonian describing the plurality of beads, based on the change information, performs analysis by applying the Hamiltonian in which the value of Planck's constant is changed, and obtains a kinematic viscosity of the fluid represented by the Hamiltonian in which the value of Planck's constant is changed, based on the analysis result.

According to still another embodiment of the invention, there is provided a computer readable medium storing a program that causes a computer to execute a process, the process including: a function of receiving simulation conditions when a fluid is represented by a plurality of particles, a plurality of beads are defined for each of the particles, and behaviors of the plurality of beads are analyzed by simulation using a path integral molecular dynamics method, and change information for changing a value of Planck's constant; and a function of changing the value of Planck's constant appearing in Hamiltonian describing the plurality of beads, based on the change information, performing analysis by applying the Hamiltonian in which the value of Planck's constant is changed, and obtaining a kinematic viscosity of the fluid represented by the Hamiltonian in which the value of Planck's constant is changed, based on the analysis result.

### BRIEF DESCRIPTION OF THE DRAWINGS

FIG. 1 is a flowchart showing procedures for obtaining a kinematic viscosity by a simulation method according to an embodiment.

FIG. 2 is a perspective view of a simulation model for calculating a kinematic viscosity.

FIG. 3 is a graph showing the shape of HFD-B2 potential.

FIG. 4 is a graph showing a kinematic viscosity ratio obtained by simulating helium 4 by a method according to the embodiment.

FIG. 5 is a graph showing a kinematic viscosity ratio obtained by simulating argon by a method according to the embodiment.

FIG. 6 is a flowchart showing procedures of a simulation method according to the embodiment.

FIG. 7 is a block diagram of a simulation device according to the embodiment.

### DETAILED DESCRIPTION

It is desirable to provide a simulation method, a simulation device, and a computer readable medium storing a program that can perform a simulation by reducing the viscosity of a fluid.

By using a value larger than the actual Planck's constant as the Planck's constant appearing in the Hamiltonian, it becomes possible to reduce the kinematic viscosity of the fluid to be simulated. By simulating the flow of a fluid having a reduced kinematic viscosity, it is possible to perform a simulation of a system with a high Reynolds number.

Before describing an embodiment, a general PIMD method will be described. In the embodiment, this PIMD method is used. In the PIMD method, one quantum particle is represented by P beads (replica), and the behavior of these beads is obtained by the classical molecular dynamics method.

First, a classical Hamiltonian of P beads corresponding to on particle in a quantum system will be described.

The partition function Z_{QM} of the quantum system is represented by the following expression.

$${Z}_{Q M} = T r ( {e}^{- β \hat{H}} ) \\ β = \frac{1}{{k}_{B} T} \qquad ( 1 )$$

Here, H hat is a Hamiltonian, T is an absolute temperature, and k_{B} is a Boltzmann constant. The symbol Tr means the diagonal sum of the matrix.

A quantum particle is represented by P beads in the classical system. The coordinates of the s-th bead are represented by r^{(s)} (s=1, 2, . . . P). For convenience, r^{(P+1)}=r⁽¹⁾. In the one particle system in the potential V(r), the classical partition function Z_{P} is represented by the following expression.

$${Z}_{P} = {( \frac{mP}{2 π {ℏ}^{2} β} )}^{\frac{3 P}{2}} \int ( {\sum }_{s = 1}^{P} {d}^{3} {r}^{( s )} ) exp ( - β {V}_{eff} ) \\ {V}_{eff} + \frac{1}{P} {\sum }_{s = 1}^{P} V ( {r}^{( s )} ) + \frac{1}{2} m {ω}_{P}^{2} {\sum }_{s = 1}^{P} {( {r}^{( s )} - {r}^{( s + 1 )} )}^{2} \\ {ω}_{P} = \frac{\sqrt{P}}{ℏ β} \qquad ( 2 )$$

Here, P is an integer and m is a quantum particle mass. The P beads corresponding to one particle are annularly connected by a spring, as shown in the second term on the right side of the expression representing the effective potential V_{eff}.

The partition function Z_{QM} of the quantum system shown in Expression (1) matches the classical partition function Z_{P} shown in Expression (2) having a parameter P taking an infinite limit. That is, the following relationship is established.

$${Z}_{QM} = {lim}_{P \to ∞} {Z}_{P} \qquad ( 3 )$$

In the PIMD method, the classical equation of motion is solved by setting the parameter P of the classical partition function Z_{P} to a finite value.

Only the potential of the system is explicitly shown on the right side of the above-described Expression (2). By introducing the virtual momentum p^{(s)} of the s-th bead and the mass M of each bead, Expression (2) can be rewritten as follows.

$${Z}_{P} = {( \frac{m P}{4 {π}^{2} {ℏ}^{2} M} )}^{\frac{3 P}{2}} \int ( {\prod }_{s = 1}^{P} {d}^{3} {r}^{( s )} {d}^{3} {p}^{( s )} ) exp ( - β {H}_{eff} ) \qquad ( 4 )$$

Here, H_{eff} is expressed by the following Expression (5).

$${H}_{eff} = \frac{1}{2 M} {\sum }_{s = 1}^{P} {( {p}^{( s )} )}^{2} + \frac{1}{P} {\sum }_{s = 1}^{P} V ( {r}^{( s )} ) + \frac{1}{2} m {ω}_{P}^{2} {\sum }_{s = 1}^{P} {( {r}^{( s )} - {r}^{( s + 1 )} )}^{2} \qquad ( 5 )$$

H_{eff} expressed by the Expression (5) can be regarded as a classical Hamiltonian corresponding to the original quantum system. The first term on the right side of Expression (5) represents the kinetic energy of beads. The second term on the right side represents the potential energy obtained by replacing the potential energy acting between the original particles so as to act between the beads. The third term on the right side represents the potential energy due to the spring force (attractive force) acting between the P beads corresponding to one particle. The third term represents that P beads are connected in a ring shape, and a harmonic vibration potential having a spring constant mω_{P}² acts between adjacent beads.

Thus, an interaction potential by superimposing the potential obtained based on the potential V(r) acting between the original particles (the second term on the right side of Expression (5)) and the potential that causes an attractive force between the beads (the third term on the right side of Expression (5)) acts between the P beads corresponding to one particle.

In the embodiment described below, M=m/P. That is, the total mass of P beads is equal to the mass of one quantum particle.

When there are a plurality of quantum particles, the statistical properties of the particles needs to be considered. The Hamiltonian H tilde of N particle systems according to Boltzmann statistics is represented by the following expression.

$$\tilde{H} = \frac{1}{2 M} {\sum }_{i = 1}^{N} {\sum }_{s = 1}^{P} {( {p}_{i}^{( s )} )}^{2} + \frac{1}{P} {\sum }_{i = 1}^{N} {\sum }_{s = 1}^{P} V ( {r}_{i}^{( s )} ) + \frac{1}{2} m {ω}_{P}^{2} {\sum }_{i = 1}^{N} {\sum }_{s = 1}^{P} {( {r}_{i}^{( s )} - {r}_{i}^{( s + 1 )} )}^{2} \qquad ( 6 )$$

The equation of motion is represented by the following expression.

$$\frac{{dp}_{i}^{( s )}}{dt} = \frac{\partial \tilde{H}}{\partial {r}_{i}^{( s )}} \\ \frac{{dr}_{i}^{( s )}}{dt} = \frac{\partial \tilde{H}}{\partial {p}_{i}^{( s )}} \qquad ( 7 )$$

Next, the Hamiltonian used in the simulation method according to the embodiment will be described. In the embodiment, ω_{P, γ} obtained by dividing ω_{P} by γ is used instead of ω_{P} in Expression (2). That is, ω_{P, γ} defined by the following expression is used.

$${ω}_{P , γ} = \frac{{ω}_{P}}{γ} = \frac{\sqrt{P}}{( γℏ ) β} \qquad ( 8 )$$

Here, γ is a real number of 1 or more. Dividing ω_{P} by γ corresponds to an operation of multiplying the value of Planck's constant by γ. By changing the value of Planck constant, the following Hamiltonian H_{γ} tilde is obtained.

$$= \frac{1}{2 M} {\sum }_{i = 1}^{N} {\sum }_{s = 1}^{P} {( {p}_{i}^{( s )} )}^{2} + \frac{1}{P} {\sum }_{i = 1}^{N} {\sum }_{s = 1}^{P} V ( {r}_{i}^{( s )} ) + \frac{1}{2} m {ω}_{P , γ}^{2} {\sum }_{i = 1}^{N} {\sum }_{s = 1}^{P} {( {r}_{i}^{( s )} - {r}_{i}^{( s + 1 )} )}^{2} \qquad ( 9 )$$

The equation of motion is represented by the following expression.

$$\frac{{dp}_{i}^{( s )}}{dt} = \frac{\partial }{\partial {r}_{i}^{( s )}} \\ \frac{{dr}_{i}^{( s )}}{dt} = \frac{\partial }{\partial {p}_{i}^{( s )}} \qquad ( 10 )$$

In the present embodiment, the equation of motion of Expression (10) is used when the PIMD method is applied. In the embodiment, the value of Planck's constant is changed as shown in Expression (8) to use a value larger than the actual Planck's constant, that is, a value that is γ times the actual value. Therefore, the quantum effect is likely to appear, and as a result, the superfluid phenomenon is likely to appear. This means that the kinematic viscosity of the fluid is reduced.

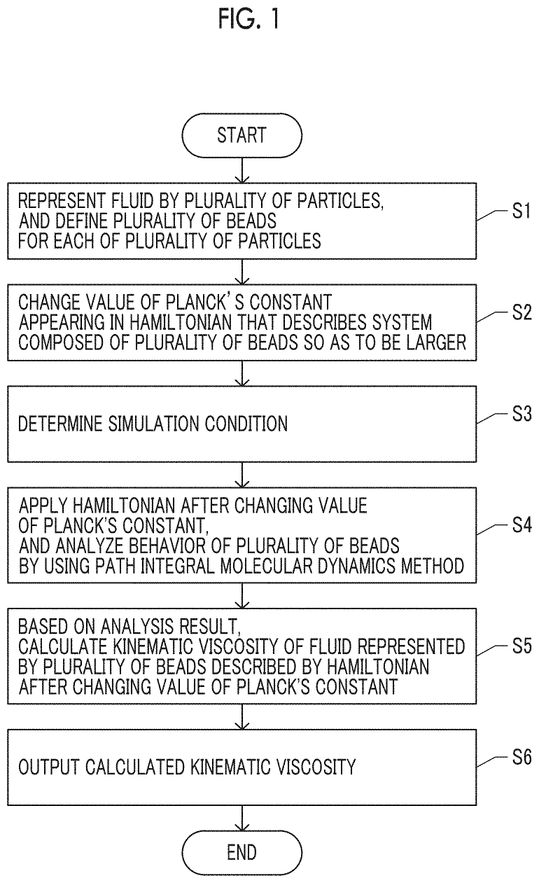

Next, a method for obtaining the kinematic viscosity of a fluid using the simulation method according to the embodiment will be described with reference to FIG. 1. This simulation method is executed by the user operating the simulation device.

FIG. 1 is a flowchart showing procedures for obtaining a kinematic viscosity by a simulation method according to the embodiment. First, a fluid is represented by a plurality of particles, and the plurality of beads are defined for each of the plurality of particles (step S1). Next, a Hamiltonian that describes a system composed of a plurality of beads is obtained. This Hamiltonian is defined by Expression (6). The value of Planck's constant appearing in ω_{P} of the third term on the right side of the Hamiltonian of Expression (6) is changed so as to be larger than the actual value of Planck's constant (step S2). Specifically, as shown in Expression (8), a value obtained by multiplying the actual value of Planck's constant by γ is used as the value of Planck's constant. The value of γ is input to the simulation device by the user.

Next, the simulation condition is determined (step S3). The simulation conditions include information defining the interaction potential between particles, particle mass, the number of beads corresponding to one particle, initial conditions, boundary conditions, a time step width, and the like. The user inputs these simulation conditions into the simulation device. Based on this simulation condition, the Hamiltonian in which the value of Planck's constant is changed is applied, and the behavior of the plurality of beads is analyzed using the path integral molecular dynamics method (step S4). Specifically, the Hamiltonian shown in Expression (9) is applied, and the equation of motion of Expression (10) is numerically solved with a certain time step. This analysis is performed by the simulation device.

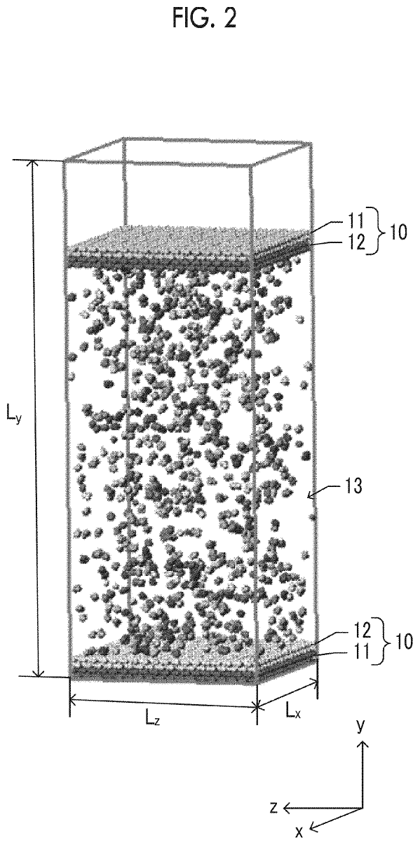

When the analysis of the behavior of the beads is completed, the kinematic viscosity of the fluid represented by a plurality of beads described by Hamiltonian in which the value of Planck's constant is changed is calculated (step S5). The simulation device calculates the kinematic viscosity. The method of calculating the kinematic viscosity will be described later with reference to FIG. 2. After the kinematic viscosity is calculated, the simulation device outputs the value of the calculated kinematic viscosity to an output device, for example, a display device.

Next, a method of calculating the kinematic viscosity of the fluid to be simulated will be described with reference to FIG. 2.

FIG. 2 is a perspective view of a simulation model for calculating a kinematic viscosity. The model space for the simulation was a rectangular parallelepiped having planes which are respectively perpendicular to the x axis, the y axis, and the z axis. A space 13 for containing a fluid is defined between a pair of flat plates 10 disposed parallel to the zx plane. One flat plate 10 is disposed on the bottom surface of the model space, and the other flat plate 10 is disposed above it. Each of the flat plates 10 has a two-layer structure including an outer rigid layer 11 and an inner elastic layer 12.

With respect to the x-axis direction and the z-axis direction, the periodic boundary condition is applied. The rigid layer 11 of the flat plate 10 disposed on the bottom surface of the rectangular parallelepiped is fixed, and a downward pressure of 1 atm is applied to the upper flat plate 10. In this state, a constant force in the x-axis direction is applied to the rigid layer 11 of the upper flat plate 10 to move it in the x-axis direction. In this case, in order to maintain the speed of the flat plate 10 constant, an attenuation term (frictional force) proportional to the speed is introduced. At a stage when the flow velocity of the liquid in the space 13 reaches a steady state, the kinematic viscosity of the fluid can be calculated from the ratio of the change rate of the flow velocity in the y-axis direction and the force applied to the flat plate 10.

Next, the result of a simulation for actually determining the kinematic viscosity will be described. The simulation was performed with helium 4 and argon as fluids.

First, the simulation performed for helium 4 will be described.

The HFD-B2 potential is used as the interatomic potential of helium 4. This is an effective potential that describes classical liquid helium. The HFD-B2 potential V_{HFDB2} is defined by the following expression.

$${V}_{HFDB 2} ( r ) = ɛ {V}^{+} ( \frac{r}{{r}_{m}} ) \\ {V}^{+} ( x ) = {A}^{+} exp ( - {α}^{+} x + {β}^{+} {x}^{2} ) - F ( x ) {\sum }_{j = 0}^{2} \frac{{C}_{2 j + 6}}{{x}^{2 j + 6}} \\ F ( x ) = \{ \begin{matrix}exp ( - {( \frac{D}{x} - 1 )}^{2} ) , & ( x < D ) \\ 1 , & ( x > D )\end{matrix} \\ {A}^{+} = 1.9221529 \times {10}^{5} \\ {α}^{+} = 10.73520708 \\ {β}^{+} = - 1.89296514 \\ {C}_{6} = 1.34920045 \\ {C}_{8} = 0.41365922 \\ {C}_{10} = 0.17078164 \\ D = 1.4135 \\ \frac{ɛ}{{k}_{B}} = 10.94 K \\ {r}_{m} = 0.2970 \times {10}^{- 9} m \qquad ( 11 )$$

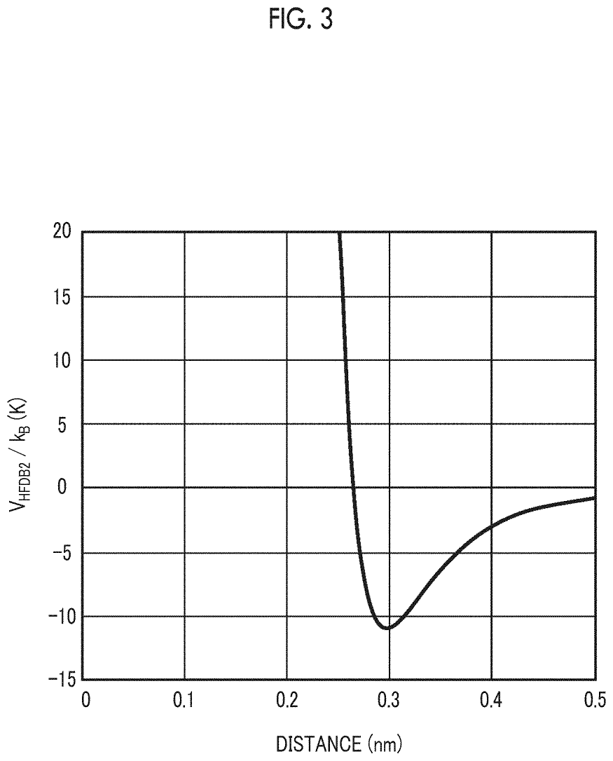

FIG. 3 is a graph showing the shape of the HFD-B2 potential. The horizontal axis represents the distance r in the unit of “nm”, and the vertical axis represents the value obtained by dividing the HFD-B2 potential V_{HFD2} by the Boltzmann constant k_{B} in the unit (K). The HFD-B2 potential has a shape similar to the Leonard-Jones potential often used as an intermolecular potential. A potential barrier due to a strong repulsive force exists near the distance r=0.25 nm, and a potential bottom exists near the distance r=0.3 nm. An attractive force acts ata distance farther than a distance at which the potential is bottom, and the potential becomes zero at the distance r→∞.

The number N of atoms of helium 4 was set to 900, and the number P of beads corresponding to one atom was set to 10. The mass of atoms of helium 4 was set to 6.64×10⁻²⁷ kg.

The number of particles forming the rigid layer 11 is 144, and the particles are disposed so as to have a face-centered cubic lattice (fcc) structure. Similarly, in the elastic layer 12, 144 particles are disposed so as to have an fcc structure. The mass of particles forming the rigid layer 11 and the elastic layer 12 was set to 5.78×10⁻²⁵ kg. The Young's modulus of the elastic layer 12 was set to 208 GPa.

The interparticle potential V₁(r) between the fluid and the elastic layer 12 of the flat plate 10 and the interparticle potential V₂(r) between the elastic layer 12 and the rigid layer 11 are defined as follows.

V₁(r)=0.75×V_{HFDB2}(r)

V₂(r)=50×V_{HFDR2}(r) (12)

The dimensions of the model space were set as follows.

L_{X}=2.52×10⁻⁹ m

L_{y}=1.51×10⁻⁸ m

L_{Z}=2.52×10⁻⁹ m (13)

The force Fₓ in the x-axis direction applied to the rigid layer 11 of the upper flat plate 10 and the attenuation coefficient c for generating the frictional force were set as follows.

F_{X}=12.0×10⁻¹¹ N

c=4.0×10⁻¹¹ kg/s (14)

In analyzing the behavior of beads using the path integral molecular dynamics method, temperature control is performed by using the velocity scaling method, until the flow of the fluid reaches a steady state. After the flow of the fluid reaches a steady state, temperature control is not performed on the fluid, and temperature control is performed only on the elastic layer 12.

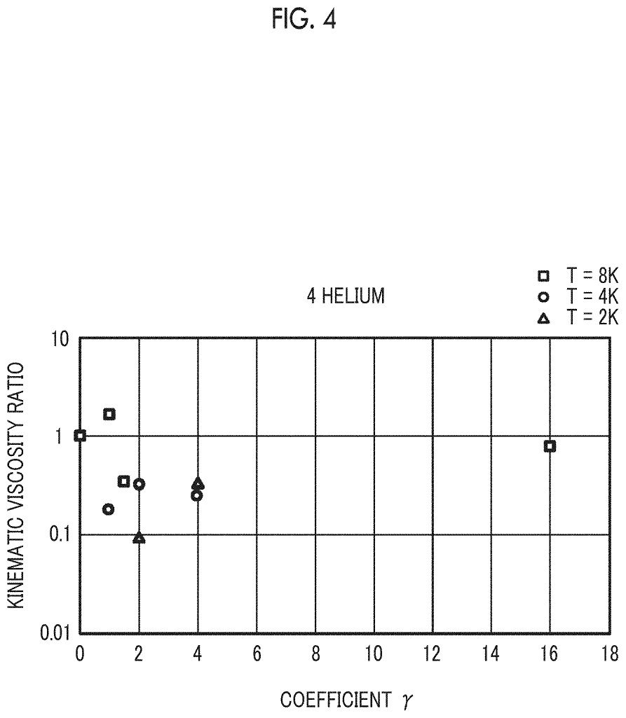

FIG. 4 is a graph showing the results obtained by performing the simulation a plurality of times by changing the coefficient γ of Expression (8) and the temperature T of Expression (1). The horizontal axis represents the coefficient γ, and the vertical axis represents the ratio to the kinematic viscosity obtained by using the ordinary molecular dynamics method instead of the path integral molecular dynamics method (hereinafter referred to as “kinematic viscosity ratio”). That is, the kinematic viscosity ratio of the original fluid before changing the value of Planck's constant by the coefficient γ becomes 1. Square symbols, circle symbols, and triangle symbols in the graph represent kinematic viscosity ratios obtained when the temperatures T=8K, T=4K, and T=2K, respectively.

When the simulation is performed under the condition that the coefficient γ is larger than 1, it can be seen that the kinematic viscosity ratio is smaller than 1. Particularly, when the coefficient γ=2, the kinematic viscosity is reduced to about 1/10 of the kinematic viscosity of the original fluid. However, even when the coefficient γ is increased, the kinematic viscosity does not significantly decrease. This is because when the coefficient γ is increased, the fluid changes from liquid to gas and the volume increases, so that the kinematic viscosity increases.

Next, the simulation performed for argon will be described.

The Leonard-Jones potential is used as the interatomic potential of argon. The Leonard-Jones potential V_{LD} is defined by the following expression.

$${V}_{L D} ( r ) = 4 ɛ [ {( \frac{σ}{r} )}^{12} - {( \frac{σ}{r} )}^{6} ] \qquad ( 15 )$$

Here, the following values are used as the potential parameters ε and σ.

∈=119.8K

σ=3.41×10⁻¹⁰ m (16)

The number N of argon atoms was set to 2700, and the number P of beads corresponding to one atom was set to 2. The mass of argon atoms was set to 6.63×10⁻²⁶ kg.

The number of particles forming the rigid layer 11 is 400, and the particles are disposed so as to have a face-centered cubic lattice (fcc) structure. Similarly, 400 particles are disposed in the elastic layer 12 so as to have an fcc structure. The mass of particles forming the rigid layer 11 and the elastic layer 12 was set to 3.09×10⁻²³ kg. The Young's modulus of the elastic layer 12 was set to 208 GPa.

The interparticle potential between the fluid and the elastic layer 12 of the flat plate 10 was the same as the interaction potential between argon atoms. The interparticle potential between the elastic layer 12 and the rigid layer 11 was set to 216 times the interaction potential between argon atoms.

The dimensions of the model space were set as follows.

L_{X}=5.41×10⁻⁹ m

L_{y}=1.51×10⁻⁸ m

L_{Z}=5.41×10⁻⁹ m (17)

The force Fₓ in the x-axis direction applied to the rigid layer 11 of the upper flat plate 10 and the attenuation coefficient c for generating the frictional force were set as follows.

F_{X}=5.0×10⁻⁹ N

c=5.0×10⁻¹⁰ kg/s (18)

In analyzing the behavior of beads using the path integral molecular dynamics method, temperature control is performed on the fluid and the elastic layer 12 by using the velocity scaling method, both until the flow of the fluid reaches the steady state and after the steady state is reached. The temperature was T=85K.

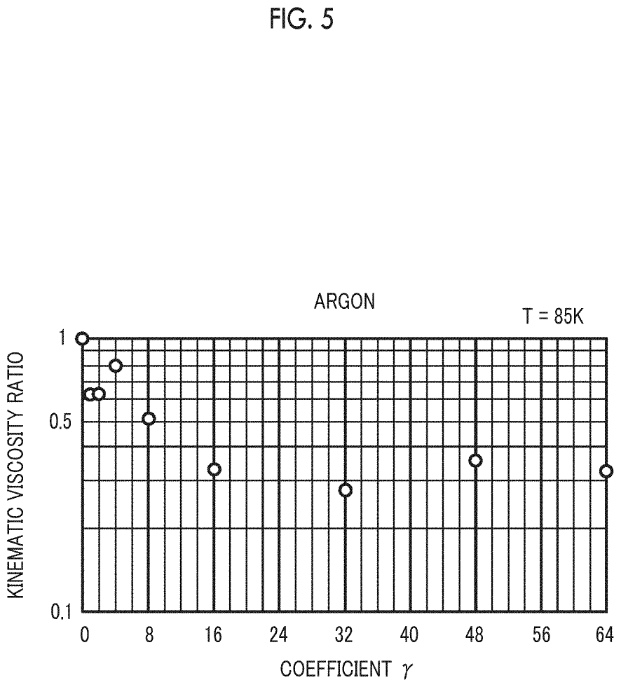

FIG. 5 is a graph showing the results obtained by performing the simulation a plurality of times by changing the coefficient γ of Expression (8). The horizontal axis represents the coefficient γ, and the vertical axis represents the kinematic viscosity ratio.

When the simulation is performed under the condition that the coefficient γ is larger than 1, it can be seen that the kinematic viscosity ratio is smaller than 1. As the coefficient γ increases, the kinematic viscosity tends to decrease. When the coefficient γ=1, the kinematic viscosity is reduced to about 1/2 of the kinematic viscosity of the original fluid. Further, when the coefficient γ=32, the kinematic viscosity is reduced to about 1/3.5 of the kinematic viscosity of the original fluid. Even when the coefficient γ is 32 or more, the kinematic viscosity does not decrease anymore. This is because when the coefficient γ is increased, the fluid changes from liquid to gas and the volume increases, so that the density decreases and the kinematic viscosity increases.

From the simulation results shown in FIGS. 4 and 5, it is confirmed that a fluid having a further reduced kinematic viscosity than the original fluid is obtained by using the Hamiltonian deformed as Expression (9) in which the coefficient γ is made larger than 1 to make the value of Planck's constant appearing in the Hamiltonian of Expression (5) larger than the actual value of Planck's constant.

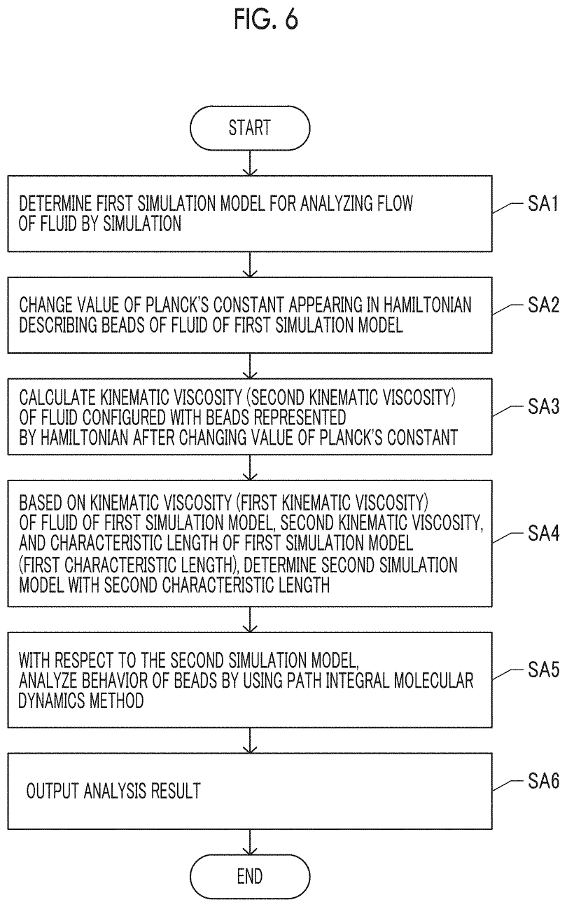

Next, with reference to FIG. 6, a simulation method according to an embodiment using a virtual fluid with reduced kinematic viscosity will be described.

FIG. 6 is a flowchart showing the procedures of the simulation method according to the embodiment. This simulation method is performed by the user operating the simulation device.

First, a first simulation model for analyzing a flow of the fluid by simulation is determined (step SA1). For example, the interaction potential of particles representing a fluid, the mass of particles, the number of beads corresponding to one particle, boundary conditions, initial conditions, or the like are determined. Next, the value of Planck's constant (Expression (2)) appearing in the Hamiltonian (Expression (6)) describing the beads representing the fluid of the first simulation model is changed (step SA2). Specifically, the coefficient γ of Expression (8) is determined. The kinematic viscosity of the fluid after the change described by the Hamiltonian (Expression (9)) including the value of Planck's constant changed by the determined coefficient γ is calculated (step SA3). The kinematic viscosity can be calculated by the simulation method shown in FIG. 1.

Based on the kinematic viscosity of the fluid of the first simulation model (hereinafter referred to as the first kinematic viscosity) and the kinematic viscosity of the fluid represented by Hamiltonian after changing the value of Planck's constant (hereinafter referred to as the second kinematic viscosity), a second simulation model in which the characteristic length of the first simulation model (hereinafter referred to as the first characteristic length) is changed is determined (step SA4). The changed characteristic length is referred to as a second characteristic length. For example, the second characteristic length is determined such that the value obtained by dividing the first characteristic length by the first kinematic viscosity is equal to the value obtained by dividing the second characteristic length by the second kinematic viscosity. The fluidof the second simulation model is described by the Hamiltonian (Expression (9)) after changing the value of Planck's constant.

With respect to the second simulation model, the behavior of the beads is analyzed by using the path integral molecular dynamics method (step SA5). This analysis is performed by the simulation device. When the analysis is completed, the simulation device outputs the analysis result to an output device such as a display device (step SA6).

Next, the excellent effects of the above embodiment will be described.

The second kinematic viscosity of the second simulation model of the above embodiment is lower than the first kinematic viscosity of the first simulation model. Therefore, even when the second characteristic length of the second simulation model is shorter than the first characteristic length of the first simulation model, the Reynolds numbers of both can be made substantially equal. Therefore, the analysis result of the flow of the fluid for the second simulation model reflects the flow of the fluid of the first simulation model. Further, since the second characteristic length of the second simulation model is shorter than the first characteristic length of the first simulation model, it is possible to reduce the dimensions of the system to be simulated while maintaining the state of the flow of the fluid. As a result, the excellent effect of shortening the analysis time using the path integral molecular dynamics method can be achieved.

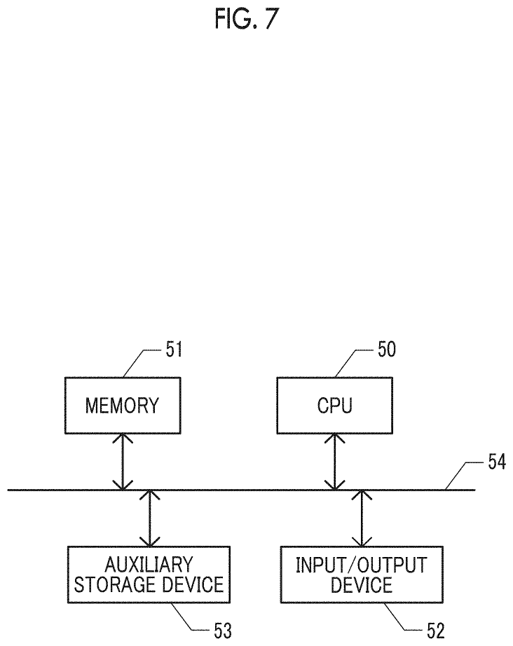

Next, with reference to FIG. 7, a simulation device according to an embodiment will be described.

FIG. 7 is a block diagram of the simulation device according to the embodiment. This simulation device is composed of a general computer, and includes a central processing unit (CPU, processing device) 50, a memory 51, an input/output device 52, and an auxiliary storage device 53. These are connected to each other by a bus 54. The input/output device 52 may be configured with an input device and an output device.

The input/output device 52 includes a keyboard, a pointing device such as a mouse, a display, a reader/writer for removable media, and a communication device. The display displays various windows, data, or the like necessary for the user's operation. The communication device performs data communication with an external device. The user operates the input/output device to instruct the computer, and input data necessary for each process. Further, the processing result is output to the input/output device 52.

The auxiliary storage device 53 is composed of a hard disk or the like, and stores the OS of the computer, a simulation program, data necessary for the simulation, processing results, and the like.

The memory 51 is composed of a Read Only Memory (ROM), a Random Access Memory (RAM), or the like. The memory 51 stores the simulation program and the like read from the auxiliary storage device 53 by the CPU 50.

The CPU 50 performs various calculations and controls the input/output device 52 and the auxiliary storage device 53, based on the OS of the computer, the viscosity calculation program stored in the memory 51, and the like.

Next, the operation of the simulation device will be described.

First, the operation when executing the simulation method for calculating the kinematic viscosity shown in FIG. 1 will be described. The information regarding the plurality of particles and the plurality of beads defined in step S1 (FIG. 1) is input to the input/output device 52, so that the simulation device acquires these types of information. Further, in step S2 (FIG. 1), the change information for changing the value of Planck's constant, for example, the coefficient γ of Expression (8) is input to the input/output device 52, so that the simulation device acquires the coefficient γ. In step S3 (FIG. 1), various simulation conditions are input to the input/output device 52, so that the simulation device acquires the simulation conditions.

In step S4 (FIG. 1), the CPU 50 analyzes the behavior of beads, by using the path integral molecular dynamics method. Further, in step S5 (FIG. 1), the CPU 50 calculates the kinematic viscosity of the fluid, based on the analysis result. After that, the CPU 50 outputs the value of the calculated kinematic viscosity to the input/output device 52 in step S6 (FIG. 1).

Next, the operation when simulating the flow of the fluid shown in FIG. 6 will be described. In step SA1 (FIG. 6), various types of information defining the first simulation model is input from the input/output device 52, so that the simulation device acquires these types of information. In step SA2 (FIG. 6), change information for changing the value of Planck's constant, for example, the coefficient γ of Expression (8) is input to the input/output device 52, so that the simulation device acquires the coefficient γ. In step SA3 (FIG. 6), the CPU 50 calculates the second kinematic viscosity by executing a simulation for calculating the kinematic viscosity.

In step SA4 (FIG. 6), the second characteristic length is input to the input/output device 52, so that the simulation device acquires information defining the second simulation model. In step SA5 (FIG. 6), the CPU 50 analyzes the behavior of beads for the second simulation model, by using the path integral molecular dynamics method. After that, the CPU 50 outputs the analysis result to the input/output device 52 in step SA6 (FIG. 6).

Next, the excellent effects of the simulation device according to the above embodiment will be described.

The simulation device according to the embodiment can calculate the kinematic viscosity of the fluid described by the Hamiltonian in which the value of Planck's constant appearing in the Hamiltonian is changed. Further, the flow of the fluid described by the Hamiltonian in which the value of Planck's constant appearing in the Hamiltonian is changed can be obtained by simulation. At this time, since the characteristic length of the simulation model is shortened, an excellent effect that the calculation time is shortened is obtained.

Needless to say, each of the above-described embodiments is merely an example, and partial replacement or combination of the configurations shown indifferent embodiments is possible. The same effects by the same configurations of the plurality of embodiments will not be sequentially described for each embodiment. Further, the embodiments of the invention are not limited to the embodiments described above. It will be apparent to those skilled in the art that various modifications, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A simulation method comprising:
when a fluid is represented by the plurality of particles, the plurality of beads are defined for each of the particles, and behaviors of a plurality of beads are analyzed by using a path integral molecular dynamics method, changing a value of Planck's constant appearing in Hamiltonian describing the plurality of beads to be larger than an actual value of Planck's constant, and analyzing the behaviors by applying the Hamiltonian in which the value of Planck's constant is changed; and
obtaining a kinematic viscosity of the fluid represented by the Hamiltonian in which the value of Planck's constant is changed, based on the analysis result.

2. The simulation method according to claim1, further comprising:
determining a first simulation model for analyzing a flow of the fluid to be simulated by simulation; and
changing a characteristic length of the first simulation model, based on the kinematic viscosity of the fluid of the first simulation model and the kinematic viscosity of the fluid represented by the Hamiltonian in which the value of Planck's constant is changed, and analyzing the flow of the fluid by applying the Hamiltonian in which the value of Planck's constant is changed, with respect to a second simulation model having the changed characteristic length.

3. A simulation device comprising:
an input device that receives simulation conditions when a fluid is represented by a plurality of particles, a plurality of beads are defined for each of the particles, and behaviors of the plurality of beads are analyzed by simulation using a path integral molecular dynamics method, and change information for changing a value of Planck's constant from an actual value of Planck's constant; and
a processing device that changes the value of Planck's constant appearing in Hamiltonian describing the plurality of beads, based on the change information, performs analysis by applying the Hamiltonian in which the value of Planck's constant is changed, and obtains a kinematic viscosity of a fluid represented by the Hamiltonian in which the value of Planck's constant is changed, based on an analysis result.

4. The simulation device according to claim 3,
wherein the processing device analyzes a flow of the fluid by applying the Hamiltonian in which the value of Planck's constant is changed.

5. A computer readable medium storing a program that causes a computer to execute a process, the process comprising:
a function of receiving simulation conditions when a fluid is represented by a plurality of particles, a plurality of beads are defined for each of the particles, and behaviors of the plurality of beads are analyzed by simulation using a path integral molecular dynamics method, and change information for changing a value of Planck's constant; and
a function of changing the value of Planck's constant appearing in Hamiltonian describing the plurality of beads, based on the change information, performing analysis by applying the Hamiltonian in which the value of Planck's constant is changed, and obtaining a kinematic viscosity of a fluid represented by the Hamiltonian in which the value of Planck's constant is changed, based on an analysis result.
